(19) United States
(12) Patent Application Publication
(10) Pub. No.: US 2022/0019909 A1
(43) Pub. Date: Jan. 20, 2022

(54) INTENT-BASED COMMAND RECOMMENDATION GENERATION IN AN ANALYTICS SYSTEM

(71) Applicant: ADOBE INC., San Jose, CA (US)

(72) Inventors: Samarth Aggarwal, Delhi (IN); Rohin Garg, Pradesh (IN); Bhanu Prakash Reddy Guda, Bangalore (IN); Abhilasha Sancheti, College Park, MD (US); Iftikhar Ahamath Burhanuddin, San Jose, CA (US)

(21) Appl. No.: 16/928,888

(22) Filed: Jul. 14, 2020

(51) Int. Cl. G06N 5/02; G06N 5/04; G06K 9/62; G06N 20/20; G06N 7/00

(52) U.S. Cl. CPC G06N 5/025; G06N 5/04; G06N 7/005; G06N 20/20; G06K 9/6256

(57) ABSTRACT

Methods, systems, and computer storage media for providing command recommendations for an analysis-goal, using analytics system operations in an analytics systems. In operation, an analytics client is configured to provide an analytics interface for receiving a selection of analysis-goal information that corresponds to an analysis-goal model. A goal engine selects an analysis-goal based on the analysis-goal information. A command engine is configured to use the analysis-goal and goal-driven models to predict probable commands for the analysis goal. The command engine also selects a next command recommendation from the probable commands. The command engine generates additional command recommendation data based on a loss function fine tuner. The additional command recommendation data can include a goal orientation score that quantifies a degree to which a command aligns with the analysis-goal. The next command recommendation and additional command recommendation output data are communicated and caused to be displayed on the analytics interface.

### BACKGROUND

Users often rely on analytics systems to collect and analyze data related to customer behavior. Such analytics systems can provide insight about customers, products, or business trends based on analyzed data. Users, in particular, use analytics systems to conduct analytics sessions on user data (e.g., user click stream data) while attempting to gain insights into a customer's activity and purchasing behavior. By way of example, an analytics system can answer questions, such as, which mobile devices make the most product conversions and/or quantify the success of a marketing campaign. However, a user (e.g., a data analyst) of the analytics systems must make many decisions when it comes to gathering insights from an increasing amount of data and capabilities in processing the data. And, the user needs to have the ability to quickly query, analyze, and draw inferences from the data.

An analytics system (e.g., a web-based analytics software application) may have many commands (e.g., software command and data commands) from which to choose, and in particular data commands can help perform actions (or set of actions) provided via the analytics system. Actions that are irrelevant to the analytics task at hand result in inefficiencies and ineffectiveness in the analytics system. Providing recommendations to users for which actions to take can greatly affect the productivity and efficiency of gathering insights from data analysis. Conventional methods used by existing analytics systems have had limited success in providing relevant guidance when attempting to accomplish specific actions. With the increasing amount of data and complexity of data analysis, improved data recommendation systems can be leveraged to efficiently and effectively generate command recommendations.

### SUMMARY

Embodiments of the present disclosure are directed towards providing command recommendations for an intent (i.e., an analysis-goal) using analytics system operations in an analytics system. The analytics system includes an analytics engine and an analytics client, such that, the analytics engine processes analytics engine input data, including analysis-goal information from the analytics client. Based on processing the analytics information, using a goal engine and a command engine, the analytics engine generates command recommendation output data including the command recommendation. The command engine generates additional command recommendation data based on a loss function fine-tune framework. The additional command recommendation data can include a goal orientation score that quantifies a degree to which a command (e.g., next command recommendation) aligns with the analysis-goal. The next command recommendation and additional command recommendation output data are communicated and caused to be displayed on the analytics interface.

### BRIEF DESCRIPTION OF THE DRAWINGS

FIGS. 1A and 1B provide block diagrams of an analytics system for providing analytics system operations, in which embodiments described herein may be employed;

FIG. 2 is an illustration of an example analytics system interface for providing analytics system operations, in accordance with aspects of the technology described herein;

FIG. 3 an illustration of an example analytics system interface for providing analytics system operations, in accordance with aspects of the technology described herein;

FIG. 4 provides a first example method of providing analytics system operations, in accordance with aspects of the technology described herein;

FIG. 5 provides a second example method of providing analytics system operations, in accordance with aspects of the technology described herein;

FIG. 6 is an illustration of an example schematic of an analytics system for providing analytics system operations, in accordance with aspects of the technology described; and

FIG. 7 is a block diagram of an example computing environment suitable for use in implementing aspects of the technology described herein.

### DETAILED DESCRIPTION

### Definitions

Various terms and phrases are used herein to describe embodiments of the present invention. Some of the terms and phrases used herein are described here, but more details are included throughout the description.

As used herein, the term “analysis-goal information” refers to a data that identifies analysis objective that a user is attempting to achieve within an analytic-session of the analytics system. An individual objective is a defined goal to be achieved during analytics-session, the objective is associated with one or more commands, such an action selection or input sequence of commands, that when performed achieve the objective. For example, analysis-goal information can be analysis of product conversion by device type or search trends, marketing research, and a single command, multiple commands, or different sequences of commands can be triggered to perform the analysis.

Analysis goal information can also specifically be a phrase or selectable user interface element that is a representation on an analysis goal. The analysis-goal information may be related to any desired action within an analytics-session that is achieved through commands in the application (e.g. adding metrics to analysis, applying dimensions to analysis, etc.). An input analysis-goal may be determined in relation to the actions taken by a user while using the analytics system. Analysis-goal information can further include log data of user activity and other data that have been collected for the user session or for the user.

As used herein, the term “analysis-goal model” refers to a machine-learning model (e.g., a bi-term topic model) that is trained using a machine-learning system to perform an assessment on log data (e.g., data set of pre-processed log data) to identify user goals. Generally, an analysis-goal model is generated to be specific to a data distribution of command sequences observed in a particular objective and information related to an analysis-goal. An analysis-goal model may be based on one or more model architectures (e.g., recurrent neural network (RNN), convolutional neural networks (CNN), frequency models, Markov models, etc.). An analysis-goal model may be trained using log data of an application (e.g., log data of a particular user or a group of users). The analysis-goal model is associated with an analysis goal.

As used herein, the term “analytics-session” refers to a temporary and interaction information interchange performed using components of an analytics system. The analytics session can specifically support data analysis operations corresponding to one or more computing devices. Data analysis operations may include actions such as collecting, tracking, reporting, analyzing, and visualizing data. For example, an analyst may access an analytics application of an analytics systems to trigger actions during the analytics session to discover data insights that are of interest.

As used herein, the term “goal-driven models” (including ensemble-based models and goal-informed models) refers to a trained machine-learning model to perform an assessment on analysis-goal to predict a next command for the analysis. Generally, a goal-driven model can also be generated based data distribution of command sequences observed in a particular objective and information related an analysis-goal. The goal-driven models may be based on one or more model architectures (e.g., recurrent neural network (RNN), convolutional neural networks (CNN), frequency models, Markov models, etc.).

As used herein, the term “command” refers to actions made by a user within an analytics-session. Commands can include data commands and software commands. Generally, commands are commands that are used in creating, modifying, or analyzing a data artifact being worked on by the user. A command may be any action in an application that facilitates the analysis of data such as adding metrics or visualizations of data. Commands may be issued as a series to achieve an analysis-goal. Commands may be provided to an application through any input method (e.g., clicks made by a user in an analytics software). Commands may relate to analyzing data and specifying which data is analyzed and how selected data is displayed. For instance, commands may relate to data metrics, dimensions, and segments. Commands of a particular analytics-session may be saved and preserved as log data. Commands can be predicted based on goal-driven models, where predicted commands are specifically data commands and not software commands.

### Overview

By way of background, users often rely on analytics systems to collect and analyze data related to customer behavior. Such analytics systems can provide insight about customers, products, or business trends based on analyzed data. Users, in particular, use analytics systems to conduct analytics sessions on user data (e.g., user click stream data) while attempting to gain insight into a customer's activity and purchasing behavior. A vast amount of data can be gathered that relates to customers and web traffic of a business (e.g., search trends, product sales, marketing). Such data can relate to a wide variety of web traffic behaviors.

Analytics systems are typically employed to process the vast amount of data to assist in decision-making (e.g., targeted marketing campaigns). Often, analytic systems attempt to analyze and understand how customers interact with a webpage (e.g., number of webpage visit, which kind of device a customer uses to interact with a company webpage when purchasing a product, whether a webpage visit leads to product conversion). A wide variety of insights into interactions with a webpage are of interest to a business (e.g., customer web traffic, sales in response to marketing campaign, types of devices completing sales, etc.).

There has been growth in the use of analytics systems because of the increase in data gathered from different data domains. Existing analytics systems provide numerous tools and capabilities to data analyst so that they can generate and visualize insights of interest from the observed data. For example, analysts using data-centric software need to make several selections within an analytics application to achieve certain objectives, gather insights from the data and take downstream decisions. Considering the sheer volume of data to be analyzed, there is now a demand on systems to query, analyze and draw inferences while limiting any delay in accessing the data or performing processing operations. However, the high complexity and large number of commands and capabilities in analytic systems can be a drawback to an analyst that only needs a subset of these actions to perform an intended analysis objective or a novice analyst in need of guidance as to productive analysis.

By way of context, two major concerns (i.e., over-filtering command options in analytics systems and the lack of skill in novice users of analytics systems) have developed in the use of analytics systems. Generally, recommendations systems have been used in the past to provide guidance in application (e.g., search systems). Recommendations systems can operate to filter out irrelevant options and provide a user with smaller number of options. When a user is faced with a raft of different options to choose from, a recommender system can act as a primary filter for options that are completely irrelevant. This leaves the user with a choice among a relatively smaller number of options.

Recommendation systems can also support training user on the different functions that are available on a particular application that the recommendation system supports. When a novice user lacks the skills and knowledge to choose the different options provided, recommender systems act as a guide for the user in making a selection. Specifically, a user may make a click selection (e.g., select command or actions that registered in log data when a user interacts with the interface of the analytics system).

Analytics systems have not been developed with adequate recommendations systems functionality, or in other words, the current combination of analytics applications and recommendation systems do not provide a technical solution that addresses the limitations of guidance and training features in conventional analytics application. For example, analysts are having to make manual selections when deciding on what functions to user to perform certain data analysis tasks. Additionally, the list of different types of specific analytics functions available on analytics application is ever-growing to meet the new and different types of insights that can be derived from data. With that, it has become impractical for data analysts to memorize and manually identify from the existing and new list of functions the particular functions that would best support their data analytics objectives.

Moreover, there are several varieties of conventional analytics systems that operate based on analyzing natural language. Analyzing natural language supports effectively understanding users' queries to automate the discovery of insights from log data. None of these conventional systems provide command recommendations (i.e., data command recommendation) based analyzing application logs and guided goal selection because goal has not been apparent or evident approach (i.e., not well-known, routine, or conventional) for developing recommendations and specifically command recommendations as discussed herein in more detail. Generally there exists no prior technology that leverages goal information for command recommendations. As such, the technical solution of inventive functionality of the present invention are based in part on determining user goal.

Because human activity is often driven by goal, natural language phrases can indicate a goal of a user working with a software application. As illustrated in the technical solution of this invention, goal can be used to provide software assistance for users in performing actions on a software application, where the software assistance is provided based on a recommendation system. At a high level, a goal (e.g., an analysis-goal of a user session in a web-analytics application) can be identified so that the user is provided command recommendations on actions to perform the identified goal. The technical solution mathematically defines the goal of a user (e.g., analysis-goal model defined based on metrics, dimensions, and segments) for an objective associated with an analytics system. In addition to analysis-goal models, goal-driven models (i.e., ensemble-based models goal-informed models), which are sequence to sequence (seq2seq) goal-based models, are developed and evaluated to predict commands based on goal.

The analysis-goal models and goal-driven models can be machine-learning models that are generated and evaluated using offline training operations. The offline training operations also include implementing a custom loss function of custom loss function fine tuning framework for the goal-driven models. The custom loss function provides additional parameters to more effectively identify a next command recommendation that corresponds to a user's goal. In particular, the loss function involves a probability distribution component, which is different for each of the identified goals, thereby generating one fine-tuned model per goal. Additionally, a goal orientation score (or measure) is generated, the goal orientation score indicates or quantifies the extent a particular command aligns with a stated goal of a user session (i.e., a degree of goal orientation of each of the models). For example, a goal orientation score can be generated on an analytics interface to provide guided assistance to a user. As such, the analytics system can further be directly used by users to keep track of the progress of the task at hand without deviation from the goal.

Embodiments of the technical solution can be explained by way of examples with reference to a web-analytics application in an analytics system with additional details provided below in the Specification with reference to corresponding illustrations. The web-analytics system can be used to track, report, analyze, and visualize web traffic. The web-analytics system can include two different sets of commands (i.e., software commands and data commands). Data commands can specifically be restricted to defined metrics, dimensions and segments. For example, in the context of a web-analytics application, an action can be a Drag-and-Drop action, a metric can be a mobile_device_type metric, and a dimension can be a Breakdown by the geocountry dimension, etc., which can correspond to data commands, while a segment can be a Loading a project, and loading the segment builder, which correspond to software commands. In this regard, pre-processed log data is generated based on specific features of software commands and data commands. More generally, data commands are commands that are used in creating, modifying, or analyzing an artifact being worked on by the user and the rest are the software commands. In the context of a photo-editing software, the command collection of Loading default type styles, Export as PNG, etc., and the command collection of Marque tool, Crop tool, Move selection tool, etc., correspond to the categories of software commands and data commands. It is contemplated that that the analytics system predicts data commands.

With continued reference to the above-stated example in web-analytics software application, often, an analyst begins his analysis with the goal to answer certain questions. The software commands merely facilitate data analysis. On the other hand, the answers sought by the analyst are closely related to the data that is being analyzed. The technical solution of the analytics system can assist the user by providing guidance to the workflow of data analysis by suggesting data commands. The analytics system includes models that support the functionality described herein. For example, analysis-goal model is generated based on application log data using a bi-term topic model. The data is a product usage log made up of a sequence of commands. Goal-informed models are generated to model sequences of commands through a recurrent neural network-based architecture by incorporating goal information. The data is a product usage log made up of a sequence of commands. This data is used for all the goal-driven models that part of the technical solution and described below in more detail. It is contemplated that while the features may vary between the analysis-goal model and the goal-driven model the data on which these models are trained can remain the same.

The analytics system operations can include operations for generating the goal-informed models. The goal-driven models can be based on an ensemble approach, where the goal information can be implicitly incorporated into the models. In this regard, a first model based on the ensemble approach is explicitly trained to model the distribution of the data of that particular goal. Further, the goal-informed models are generated based on explicitly identified goal information. While an ensemble approach having a set of classifiers can be a competitive baseline for multi-class classification task, this approach of providing the task information implicitly can be supplemented in some situations to provide improved results. For example, ensemble-based models may lack generalizability, while predicting data commands for sequences which do not align with the goal. As such, additional constraints can be implemented on additional model variants of sequence to sequence models to capture the relation between goal and the command sequence by providing the information explicitly. The additional set of goal-informed models have the advantage of training the model on relatively larger set of data thereby resulting in better accuracy.

In this regard, the analytics system supports model variants based on Goal Concatenated Representation (GCoRe), Goal Concatenated Commands (GComm), and Goal Appended Inputs (GAI). With reference to Goal Concatenated Representation, this model administers goal information at the fully connected layer in slight contrast to traditional LSTM (Long-Short Term Memory). Providing the goal information at the fully connected layer aids the model to keep track of the goal while predicting the next data command. A selected representation of the goal (e.g., a hot goal or prominent goal) is concatenated to the effective representation of the input command sequence, obtained after the LSTM encoder layer.

Turning to the Goal Concatenated Commands, the encoded representation after the LSTM layer can be configured to not take the goal into account. As a result, it can be difficult to find distinct goal clusters in the latent representation space. Therefore, in this approach and the subsequent approach, the goal information is provided before the LSTM layer. It is expected for these models to incorporate the goal information while representing the input sequences and thereby provide better results. A selected representation of the goal (e.g., a hot goal or prominent goal) representation of the goal is concatenated to each of the embeddings of the commands in the sequence and is fed as input to the LSTM encoder.

Finally, the Goal Appended Inputs model assumes the goals and the commands to be in the same latent representation space. The goal information is provided as input at the first time step of the LSTM unit. The goal and command embeddings are trained together in the same K-dimensional space to generate cluster representative embeddings for the goals. As such, as described above these different goal-driven variant models are configured to support the next data command prediction based on sequence to sequence modeling.

The analytics system includes analytics system operations that support a loss function fine tuning framework. By way of context, a standard cross-entropy loss function, when applied to these goal-driven models, makes sure that the recommended data commands are actually aligned with the input sequence. However, a severe limitation to this standard loss function in this analytics system setting the loss function may not be configured to consider the goal orientation while penalizing the models. These models do not have access to crucial information provided by the BTM, which is the definition of a goal.

As such, the analytics system operations include using definition of goals, the probability distribution over data commands, to incorporate the definition of the goals into the loss function. In order to ensure this, the analytics system operations introduce Kullback-Leibler divergence into the loss function. The KL divergence measures how much a probability distribution differs from a reference distribution. Minimizing the KL divergence means optimizing the predicted command probability distribution to be close to the data command distribution of the goal. Therefore, the analytics system operations introduce a two-term weighted loss function in which the first term is a scaled version of the cross-entropy loss and the second term is the KL Divergence between the predicted probability distribution and the chosen goal distribution. A hyperparameter alpha is the balancing factor for both the losses.

The analytics system operations include support for a fine tuning as part of the loss function fine tuning framework. The proposed loss function used in the proposed models steers the recommender systems to produce data commands relevant to the goal at hand. The proposed loss function involves goal specific component (e.g., goal specific component Q). Goal specific trained models are only exposed to the sequences specific to a goal and thus display aberrant behavior for previously unseen command sequences from other goals resulting in loss of generalizability. Models trained on large volumes of diversifying data from different goals overcome the problem of overfitting. For this reason, the goal informed models, when trained on global data using the proposed loss function have an inherent advantage of learning to represent the sequences better compared to the goal specific data models. These representations are captured through the embeddings, the hidden state weights of the LSTM layer, and the fully connected layer parameters of these models. Therefore, the analytics system operation support utilizing the trained weights of these models for initializing the parameters. The analytics system fine tunes the models to be goal specific by retraining the models on the data specific to this goal with the modified loss function. Consequently, these fine-tuned models are trained to provide accurate and goal relevant data command recommendations. Another indispensable advantage of these models is their superior performance for low resource goals, that is, goals with less training data.

The analytics system operations includes support for an analytics interface on an analytics client. The analytics client (e.g., using a browser extension) can facilitate interaction between frontend and the backend. For example, a user's interaction with the analytics interface is monitored in real-time and sequence of commands are sent to our models in the back-end. With specific reference to a browser extension implementation, when a user clicks on the extension icon, a layout appears, which initially consists of the goal selection section. After a user choses a goal, then the command recommendation panel appears, that suggests the data commands to be used based on the command sequence observed so far.

Embodiments of the present invention are directed to simple and efficient systems, methods, and computer storage media for providing command recommendations for an analysis-goal, using analytics system operations in an analytics systems. The analytics system includes an analytics engine and analytics client, such that, the analytics engine processes analytics engine input data using a goal engine and a command engine to generate command recommendation output data including the command recommendation.

By way of example, during an offline processing phase, application log data can be used to generate analysis-goal models. The application log data (e.g., user click stream data) is analyzed to generate pre-processed log data, where the pre-processed log data is used to generate analysis-goal models. The application log data is pre-processed into a suitable data set (e.g., data metrics, dimensions, and segments of commands) to help make command recommendations for data commands of the application log data. On an analytics client running an analytics session (e.g., web-analytics software application), analysis-goal information can be accessed. During the analytics session, a user may provide an analysis-goal information that is based on analysis-goal models. Analysis-goal information can be a goal phrase (e.g., identify sales made to a particular device type), where a plurality of goal phrases are presented for selection. The analysis-goal information may be a phrase identifying an analysis-goal associated with an analysis-goal model. Analysis-goal information can further include log data of user activity and other data that have been collected for the user session or for the user.

The analysis-goal is then processed through goal-driven models (including ensemble-based models and goal-informed models) to generate a command recommendation. In particular, based on the analysis-goal, a probable command that corresponds to the modeled analysis-goal is identified. At a high level, probable commands are identified based on goal-driven models that are variants of sequence to sequence models. The goal-driven models are trained on a plurality of previous sequences of commands to predict probable commands for corresponding analysis-goals. As such, for an analysis goal, for example “identify sales made to a particular device type,” the analytics system can provide a command recommendation, such as “add device type identifier” as a next command recommendation. The command recommendation is generated and communicated via an analytics user interface (e.g., a user assistance interface) of the analytics system. By considering the goal of the user in generating command recommendations, the analytics system can filter out irrelevant commands, leaving primarily commands that are relevant to the user goal, and the analytics system can also provide guidance to a novice user to allow efficient data analysis.

In operation, a goal engine is configured to generate analysis-goal models an identify analysis-goals based on log data. An analytics client is configured to provide an analytics interface for receiving a selection of analysis-goal information that corresponds to an analysis-goal model. The goal engine receives the analysis-goal information and selects an analysis-goal based on the analysis-goal information. The command engine is configured to use the analysis-goal and goal-driven models to predict probable commands for the analysis goal. The command engine also selects a next command recommendation from the probable commands. The command engine generates additional command recommendation data based on a loss function fine tuner framework. The additional command recommendation data can include a goal orientation score that quantifies a degree to which a command (e.g., next command recommendation) aligns with the analysis-goal. The next command recommendation and additional command recommendation output data are communicated and caused to be displayed on the analytics interface.

Accordingly, the embodiments described herein address the above-described issues of conventional analytics system by generating command recommendations based on an analysis-goal of an analytics-session and goal-models having probable sequences of commands. In particular, generating command recommendations based on a determined analysis-goal of an analytics session support providing data-command recommendations that are more closely aligned with the objective of the analytics session. With recommendations that are relevant to the objective of the analytics session, an improved user interface can be provided since commands that are irrelevant to the current session can be filtered and a user can more effectively and efficiently select data-command that support gaining insights into data within an analytics system.

### Analytics System

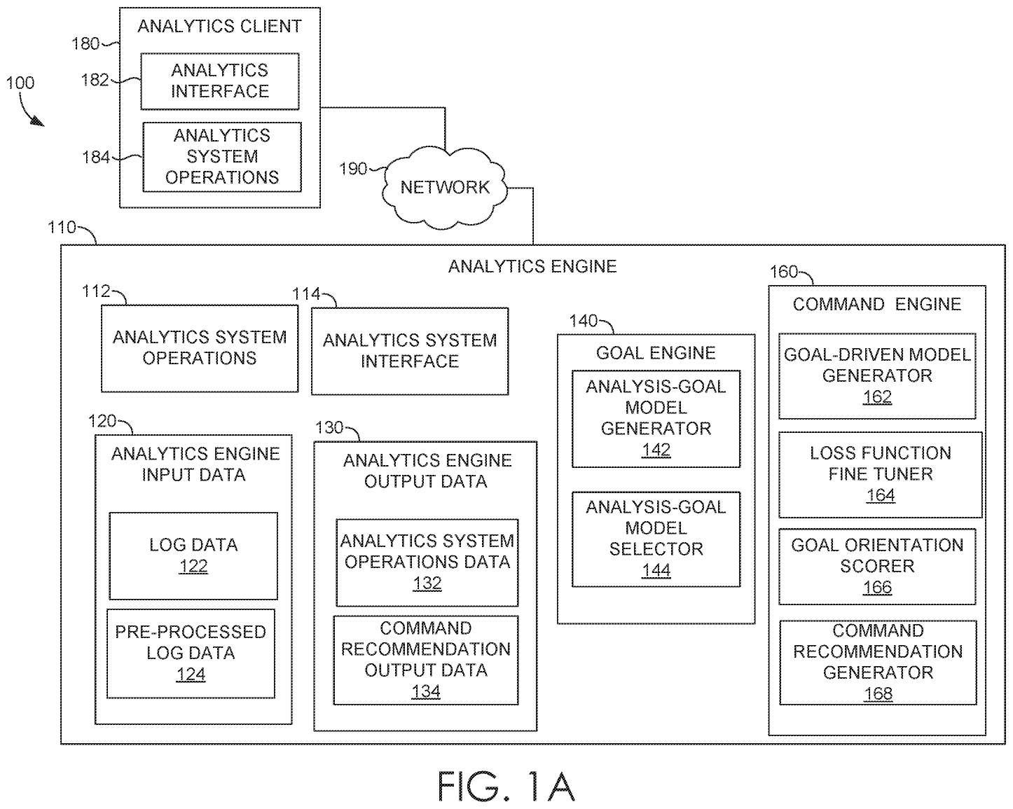

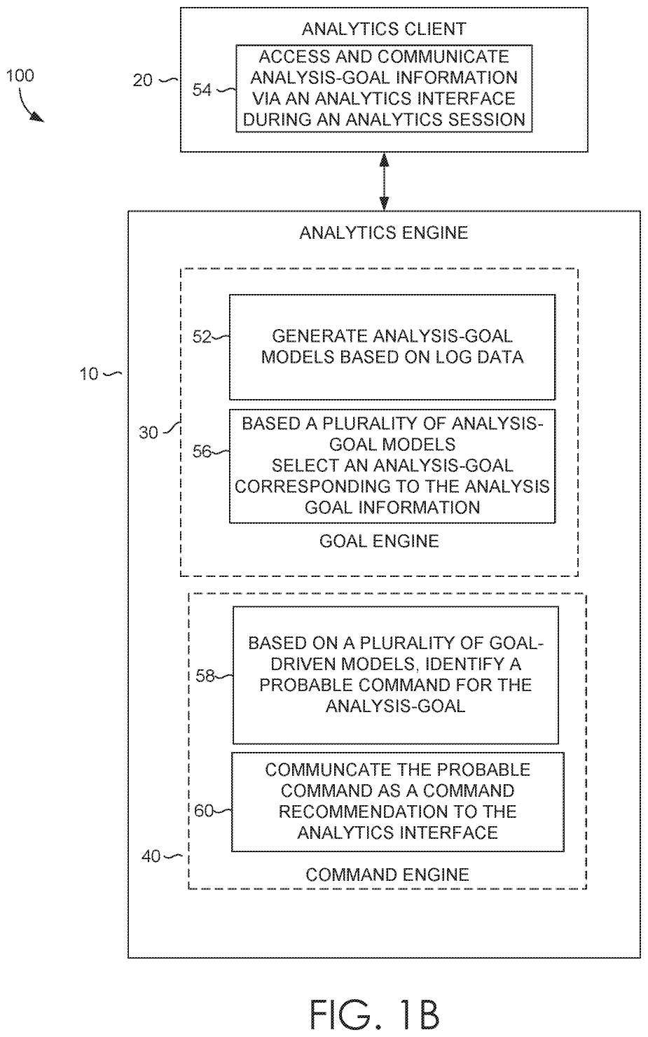

With reference to FIGS. 1A and 1B, FIGS. 1A and 1B illustrate an example analytics system 100 in which methods of the present disclosure may be employed. In particular, FIGS. 1A and 1B show a high level architecture and operations of the analytics system 100 in accordance with implementations of the present disclosure. Among other engines, managers, generators, selectors, or components not shown (collectively referred to herein as “components”), the technical solution environment of analytics system 100 includes an analytics engine 110 (including analytics system operations 112, and analytics system interface 114) analytics engine input data (including logo data 122, and pre-processed log data 124), goal engine 140 (including analysis-goal model generator 142, analysis-goal model selector 144) and command engine (including goal-informed model generator 162, command recommendation generator 164, analytics client 180 (including analytics interface 182, and analytics system operations 184) and network 190.

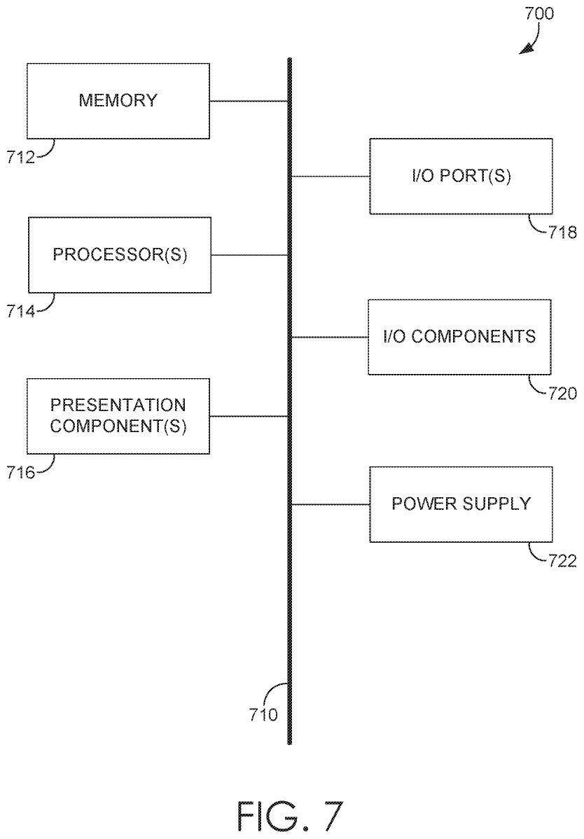

The components of the analytics system 100 may communicate with each other over one or more networks (e.g., public network or virtual private network “VPN”) as shown with network 190. The network 190 may include, without limitation, one or more local area networks (LANs) and/or wide area networks (WANs). The analytics client 170 may be a client computing device that corresponds to the computing device described herein with reference to FIG. 7. Analytics system operations (e.g., analytics system operations 112 and analytics system operations 184) can be carried out by a processor executing instructions stored in memory as further described with reference to FIG. 7.

The components of the analytics system can be used to execute analytics system operations to command recommendations for an analysis-goal in an analytics systems. The analytics system includes an analytics engine and analytics client, such that, the analytics engine processes analytics engine input data using a goal engine and a command engine to generate command recommendation output data including the command recommendation.

With continued reference to FIG. 1A, at a high level, the analytics system 100 includes an analytics engine 110 and an analytics client 180, such that, the analytics engine processes analytics engine input data 120, including analysis-goal information, which is received from the analytics client 180. Based on processing the analytics-goal information, using a goal engine 140 and a command engine 160, the analytics engine 140 generates command recommendation output data including a command recommendation for the analysis-goal information.

The goal engine 140 is configured to generate analysis-goal models based on log data. The goal engine is also configured to identify an analysis-goal for analysis-goal information that is received from the analytics client 180. The analysis-goal corresponds to an analysis-goal model. The analysis-goal models are generated using log data. The logo data includes a plurality of previous sequences of commands that are analyzed using a bi-topic model.

The analytics client 180 is configured to provide an analytics interface (e.g., analytics interface 182). The analytics client 180, using the analytics interface 182, receives a selection of analysis-goal information. The analysis-goal information is based on a user selection of the analysis-goal from the plurality of analysis-goals. The analysis-information may be a phrase representing an analysis-goal having a corresponding analysis-goal model. The analytics client 180 communicates the analysis-goal information to the analytics engine 110. The analytics client is also configured to receive the next command recommendation and other command recommendation output data. The analytics client 180 can cause display of the command recommendation and the other command recommendation output data.

The command engine 160 is configured to use the analysis-goal and the goal-driven models to predict probable commands for the analysis goal. The command engine 160 also selects a next command recommendation from the probable commands. The command engine 160 is also configured to generate (e.g., using loss function fine tuner 164) other command recommendation output data (e.g., goal orientation data) based on a loss function fine tuner that is applied to the goal-informed model. The command engine 160 is further configured to score a goal orientation (e.g., goal orientation score 166) based on a loss function fine tuner that is applied to the goal-informed model. The other command recommendation data can include a goal orientation that quantifies a degree to which a command (e.g., the next command recommendation) aligns with the analysis-goal. The next command recommendation and the additional command recommendation output data are communicated to the analytics client.

With reference to FIG. 1B, the analytics system 100, analytics engine 10, analytics client 20, goal engine 30, and command engine 40 correspond to the component described with reference to FIG. 1A. At a high level, at step 52, the goal engine 30 generates analysis-goal models based on log data. The analytics client 20 causes display of an analytics interface, at step 54, accesses and communicates a selection of analysis-goal information that corresponds to an analysis-goal model.

At step 56, the goal engine 30 selects an analysis-goal based on the analysis-goal information. The analysis-goal is selected based on a model that corresponds to the goal information. At step 58, the command engine 40 identifies a probable command based on the analysis-goal and goal-driven models. The command engine 60 also selects a next command recommendation from the probable commands. The command engine further generates additional command recommendation data based on a loss function tuner. The additional command recommendation data can include a goal orientation score that quantifies a degree to which a command (e.g., next command recommendation) aligns with the analysis-goal. The next command recommendation and additional command recommendation output data are communicated and caused to be displayed on the analytics interface.

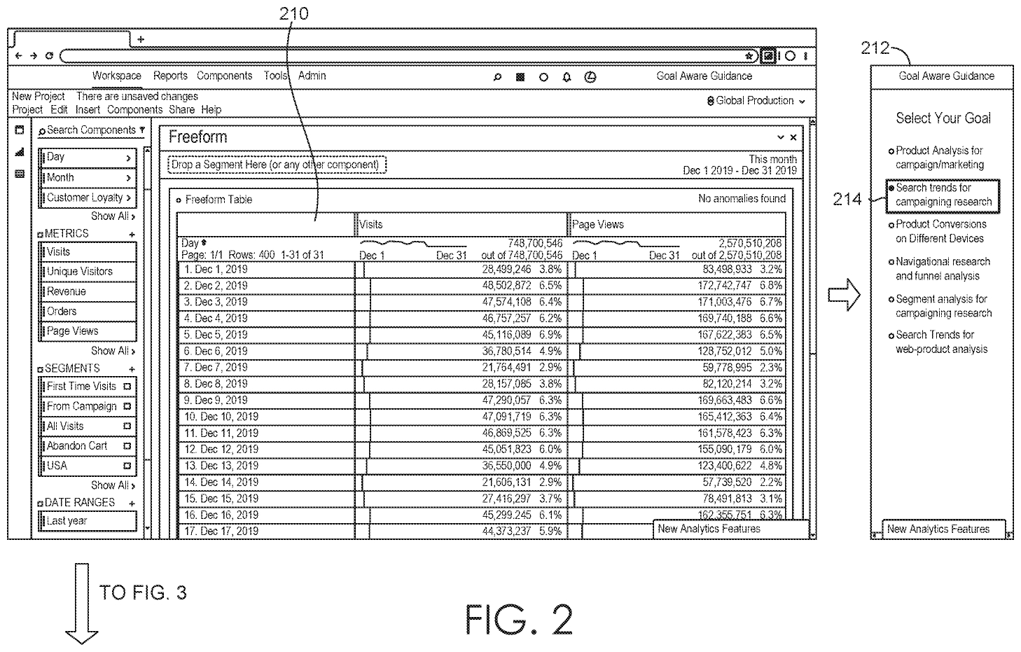

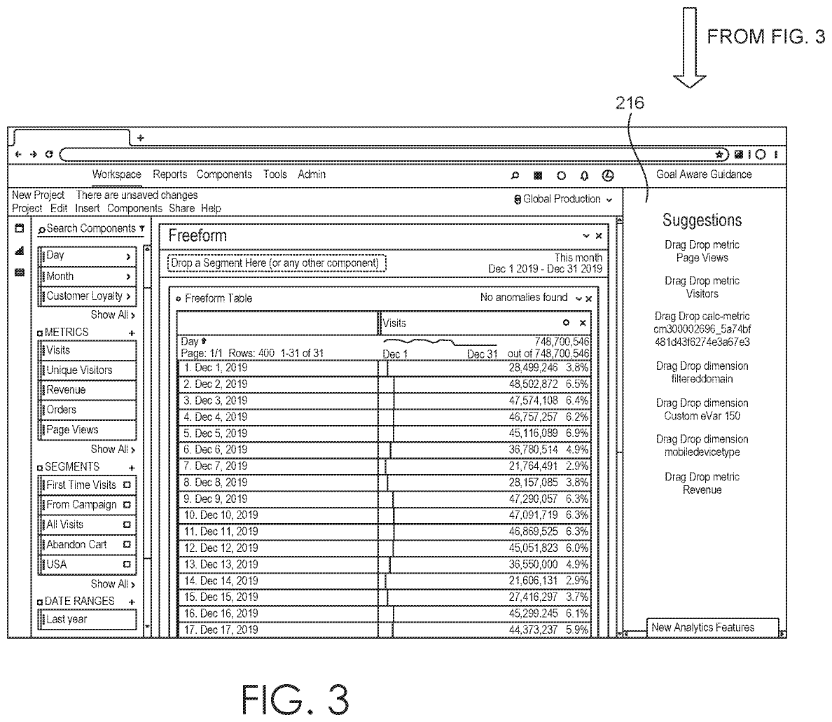

Embodiments of the present invention may further be described with reference to FIGS. 2 and 3 that provides illustrations of analytics operations with reference to user interfaces associated with components of the analytics system 100. At a high level, the analysis system operations and user interfaces support improving computer operations based on improving providing command recommendations based on analysis-goal. Additionally, the analytics engine 110 allows for user interface interaction models that use the analysis system operations to provide novel user interfaces as described in more detail below.

The analytics system operations includes support for an analytics interface on an analytics client. The analytics client (e.g., using a browser extension) can facilitate interaction between frontend and the backend. For example, a user's interaction with the analytics interface is monitored in real-time and sequence of commands are sent to our models in the back-end. As shown in FIG. 2, a web-analytics layout 210 is generated (e.g., using an analytics interface and by way of example, a browser extension). The web-analytics layout 210 can include a goal selection section of the web-analytics layout 212 (e.g., Goal Aware Guidance 212). A user selection of analysis-goal information (e.g., “Search Trends for Campaigning Research 214) can be received. For example, a user choses a phrase from a list of phrases corresponding to analysis-goal information, analysis-goal, and analysis-goal models. With reference to FIG. 3, the selection of analysis-goal information can trigger generation of command recommendation section (e.g., Goal Aware Guidance 216) having a plurality of commendation recommendations based on command recommendation data. For example, a command recommendation panel appears, that suggests the data commands to be used based on the command sequence observed so far. It is further contemplated that additional command recommendation data (e.g., goal orientation score—not show) can be presented via the web-analytics layout 212 or other portion of the analytics interface.

### Exemplary Methods

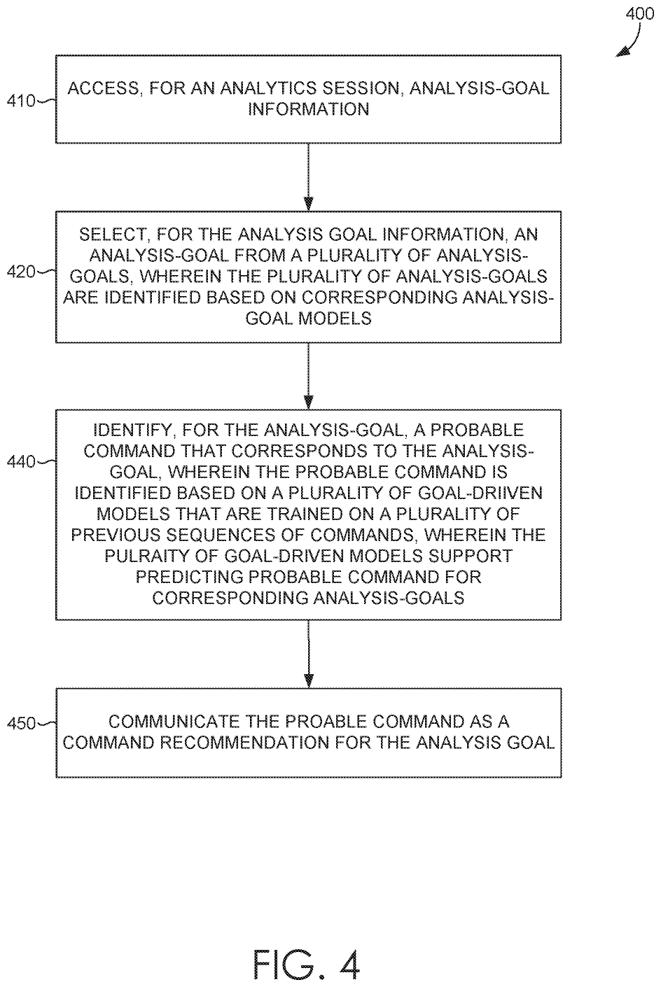

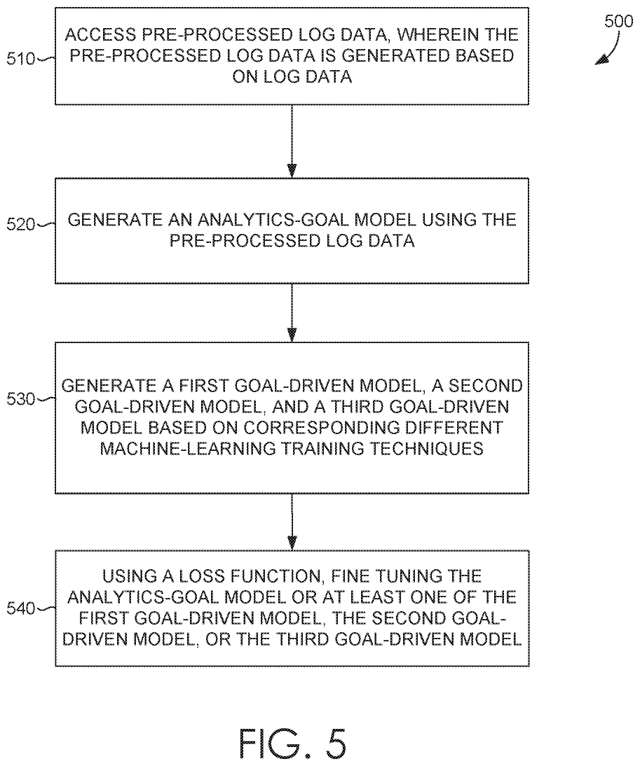

With reference to FIGS. 4 and 5 flow diagrams are provided illustrating methods for providing command recommendations for an analysis-goal, using analytics system operations in an analytics systems. The methods may be performed using the analytics system described herein. In embodiments, one or more computer storage media having computer-executable instructions embodied thereon that, when executed, by one or more processors can cause the one or more processors to perform the methods in the analytics system.

Turning to FIG. 4, FIG. 4 is a flow diagram illustrating a method 300 for generating command recommendation recommendations based on analytics system operations. Initially, at block 410, an analysis-goal is received. At block 420, an analysis-goal, for analysis goal information, is selected from a plurality an analysis-goal. The plurality of analysis-goal are identified based on corresponding analysis-goal models. At block 430, a probable command for the analysis-goal is identified. The probable command is identified based on a plurality of goal-informed models that are trained on a plurality of previous sequences of commands. The plurality of goal-informed models support predicting probable command for corresponding analysis-goals. At block 440, communicate the probable command as a command recommendation for the analysis goal.

Turning to FIG. 5, FIG. 5 provides a flow diagram illustrating a method 400 for providing analytics system operations. Initially a block 510, pre-processed log data is accessed. The pre-processed log data is generated based on log data. At block 520, an analytics-goal model is generated using the pre-processed log data. At block 530, a first goal-driven model, a second goal-driven model, and a third goal-driven model based on corresponding different machine-learning training techniques. At block 540, using a loss function, the analytics-goal model, or at least one of the first goal-driven model, the second goal-driven model, and the third goal-driven model are fine-tuned.

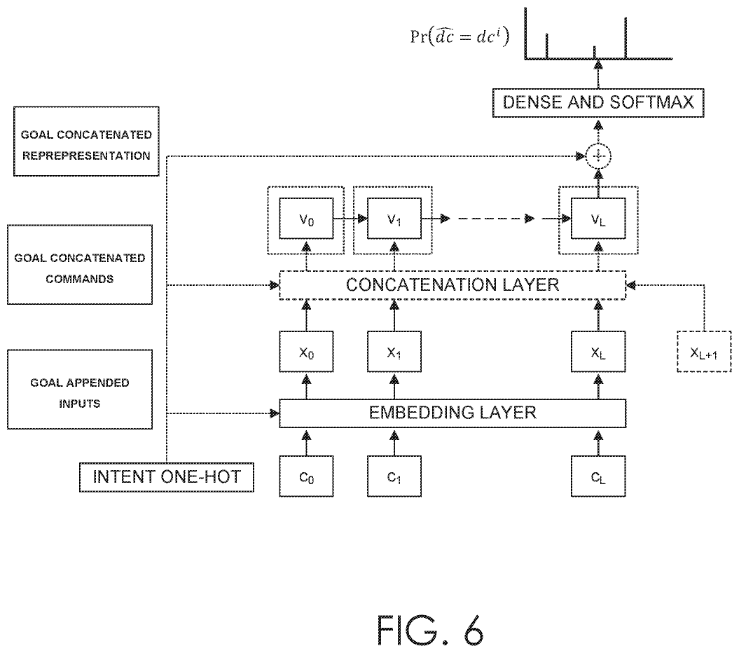

Additional detailed discussion is provided below, with reference to FIG. 6, to support disclosure of the technical solution of the embodiments of the present invention. The technical solution is based on analytics system operations that support generating a dataset (i.e., pre-processing log data), generating goal-driven models including analysis-goal models and goal-driven models. The analytics system operations for generating the data set can be explained by way of example with reference to a data set of a web-analytics system. The web-analytics system can be used to track, report, analyze and visualize web traffic. User activity within the web-analytics system can be captured as application log data “log data”. The log data include clicks that are captured while the user interacts with the system. The clicks can be referred to as commands, and specifically as used herein commands refer to data commands. The data commands can be distinguished from software commands in that the data commands specify data to be analyzed. Data commands can further be split into a class and corresponding variable.

During analytics sessions, selection of commands as indicated in the log data is iterative. For example, a spreadsheet application, while a software command can refer to opening, loading, saving a document, a data command can refer to actions such as column selections, sorting a data column, or increasing or decreasing order. As such, the class of data commands can correspond to sorting and the variable is the value on which the data are sorted. As discussed herein in more detail, analytics system functionality (e.g. providing explanations for patterns in user behavior) can be based on data commands and software commands, as such, the command recommendation operations can specifically provide guidance for how to identify information in data, so prediction of commands can specifically be for prediction of data commands.

The analytics system operations support pre-processing log data to analyze analyzing patterns of user behaviors in the log data. In one implementation of pre-processing the logo data is extracted and split into sessions using various techniques (e.g., sessions may be split based on selection on signing out of the session). The analytics system operations include identifying total number of sessions and total number of unique commands. A total number of unique command can be identified based on dropping the command that were logged to indicate user interface event and not explicitly executed by the user. The sequence of commands can include both software commands and data commands. Additional click events that are not software command and data commands can be discarded.

A sliding window approach is used for analyzing sessions of user activity. A window encompassing a number of commands is defined, such that the window is placed at each command position of the sequence of commands in the log data. Sequence modeling includes training the model to predict the next data command in the sequence of data.

SC,DC,DC,SC, . . . ,SC,SC,DC,DC,SC (1)

For example, with reference to (1), for a session of user activity, sequence data is generated for model training based on identified sequences of commands in sessions from the log data. For the sequence of data, a window (e.g., a window including two or more commands is identified) to train the sequence model to predict an immediate next command for a sequence of commands after the identified window ends (data command in bold). An average number of commands per session can be identified such that sessions with less than the average number of commands are dropped, and session with length greater than 30 can be handled based on the sliding window approach. The total number of sequences from a training data set can be split for training, validation for test sets on the basis of sessions.

The analytics system operation support identifying an analysis goal based on the pre-processed log data. In particular, analytics-goal models are generated based on the pre-processed log data. In this regard, goals from log data and providing goal information for command recommendation (e.g., at a command recommendation engine). As discussed, it contemplated that the log data can include more than one category of commands (e.g., software commands and data commands). As such, sequences of commands can include both the first category of commands and the second category of commands. In one implementation, the analytics system operations support predicting only a single category of commands. For example, next command prediction can be exclusively for data commands.

In operation, a command distribution ϕ_{I} can be determined from the log data. The command distribution is determined using a bi-term topic model (BTM). At a high level, a BTM models topics in data based on short texts in the data, where topics are identified in the data by directly modeling the generation of word co-occurrence of patterns (i.e., bi-terms) in a whole corpus to enhance topic learning. The BTM is applied to the log data to alleviate data sparsity issues that is command with other types of topic model approaches (e.g., the BTM obviates issues arising due to co-occurrence matrix for each and every pair of commands being very sparse). The command distribution contains probability values for all the commands, for example, software commands and data commands. As such, when predicting command recommendations for a single command category, the probabilities that pertain to the command category are considered and normalized to generate a distribution for goal as shown in the formula below.

$$P ( d c = d {c}_{i} \vert goal = I ) = \frac{{ϕ}_{I} [ d {c}_{i} ]}{{Σ}_{c ∈ D C} {ϕ}_{I} [ c ]} \qquad ( 2 )$$

where d_{c}_{ᵢ}∈DC is the i^{th} data command, ϕ_{I}[c] denotes the probability of the command c in the command distribution for the goal I. The computed distribution, P(dc|goal=I), is considered as the definition for the goal I.

The analytics system operations for identifying goal further includes goal coherence (i.e., deciding on the number of goal to extract from the log data). Goal coherence includes standardizing coherence evaluation metrics. As such, goal coherence includes defining an unsupervised goal ranking measure based on three prototypes of irrelevant and insignificant goals. A goal significance score is computed by applying various similarity measures such as cosine, correlation and dissimilarity measures to these three prototypes. A score (e.g., a pairwise score based on a pairwise function) can be used to measure compute score for all pairs of commands (e.g., data commands) in a goal cluster. As discussed further herein, the analysis-goal models are used to select analysis-goals for user session.

The analytics system operations further support determining an analysis-goal information. For an analytics session, an input analysis goal is determined. For example, a user selection of an analysis-goal can received based on a selection of a phrase (i.e., phrase of an input analysis goal) at the start of an analytics session, where the phrase aligns with the user's objective for the analytics session. It is contemplated that the analysis-goal information can be received in other ways. For example, based on current user activity or previous user activity or other programmatically defined parameters, the analytics operations may automatically determine analysis-goal information that is communicated to from an analytics client supporting the analytics session to the analytics engine. As such, other variations and combinations of operations for determining analysis-goal information are contemplated with embodiments of the present disclosure.

The analytics system operations further support selecting an analysis goal based on analysis-goal information. An ensemble approach is used to identify different goals (e.g., goal models) based on implicitly incorporated goal information. In particular, different goal models (e.g., analysis-goal models) are generated. Each goal model is trained to model the distribution of the log data of a particular goal. In one implementation, a multi-layered Long Short-Term Memory (LSTM) is used to encode the input sequences of commands into vectors of fixed dimensionality. Given a sequence S with cᵢ∈DC∪SC, i in [0, L] commands, the commands are first embedded through an embedding matrix. The sequence of embedded commands is the provided as an input to an LSTM encoder which computes representations of the commands by summarizing the information.

The representation from the time step of the LSTM hidden unit, denotes the semantic representation of the command sequence in the latent space. It is then processed as input to a fully connected layer, followed by a softmax layer for predicting the succeeding command (e.g., data command) in a given sequence. Mathematically at each step of the command prediction, the following probabilities are computed to generate next data command in the sequence S:

Pr(\hat{d}c=dcᵢ|c₀,c₁, . . . ,c_{L}) (3)

K such models are trained, one for each of the K goals identified through the BTM model. The commands which are model predictions are the ones which have the top probabilities.

arg max Pr(\hat{d}c=dcᵢ|c₀,c₁, . . . ,c_{L})

dcᵢ∈DC (4)

The ensemble approach can further include a convolution operation with max-over-time pooling operation layer to generate embedding representations for the command sequences. Advantageously, the convolution operation captures the most significant feature (i.e., a feature with the highest value) for each feature map. The max-over-time pooling further handles the problem of having variable length command sequences. The features obtained from the convolution filters are concatenated to produce a single representation of the command sequence. This representation is further processed through dense and soft max layers for predicting the next data command in the given sequence. The mathematic representation of this model remains the same as shown above.

Command distribution based on machine learning Probability for both software commands and data commands, The command recommendation operations support command recommendation identification and communication (e.g., a command engine is configured to identify a command recommendation and communicate the command recommendation). Command recommendation operations generate several different command recommendation models (i.e., model variants). The command model variants can each be sequence to sequence (seq2seq) models. In generating the model variants, the model variants are compared to traditional approaches such as popularity based models, bags-of commands models, and Markov models.

The model variants based on based on goal information is two main operations. First, goal information (e.g., a goals generated from dataset of log data) is provided to the model variants and, second, the goal information is can be used to build the model variants as goal informed models. Generating a predicted command as a command recommendation. In one implementation, the modeled analysis-goal is received

The analysis recommendation operations includes identifying variants of sequence to sequence models (seq2seq). The variants are compared again traditional approaches such as popularity based models, bag-of-commands models, and Markov models. The modeled analysis-goal (i.e., goal information) is provided as input to the seq2seq models to make predictions for probable commands. In particular, two approaches can be implemented for the input analysis-goal (1) providing data that corresponds to the goal; and 2 building goal informed models.

Training can also include generating a goal orientation measure. The goal orientation measure can specifically be a score for the models and fine-tuned models described herein. The goal orientation measure can be based on accuracy of the command recommendation and a goal awareness (i.e., probability of a command recommendation for a particular goal). Train in this manner demonstrates that after fine-tuning the models, demonstrate that the recommended data commands are still aligned with the goal with the accuracy intact.

Training the models described herein can also be based on adversarial testing. Adversarial testing include providing as data inputs into the model data distributions that are different from what the model is initially trained on. For each goal, the specific fine-tuned model, data points corresponding to the other goals are provided as inputs. The models are thus more accurate when fine-tuned in that they are trained to predict the accurate data command for a give sequence, and then fine-tuning alters the models to tune the recommendations towards a specific goal. Advantageously, when a user deviates from the specified goal, the sequence of command might not map to the goal; however the command recommendation can be provided to steer the user back toward the input analysis-goal.

### Exemplary Operating Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

The technical solution system can further include a machine learning system. a machine-learning system may include machine-learning tools and training components. Machine-learning systems can include machine-learning tools that are utilized to perform operations in different types of technology fields. Machine-learning systems can include pre-trained machine-learning tools that can further be trained for a particular task or technological field. At a high level, machine-learning is a field of study that gives computers the ability to learn without being explicitly programmed. Machine-learning explores the study and construction of machine-learning tools, including machine-learning algorithm or models, which may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools. It is contemplated that different machine-learning tools may be used, for example, Logistic Regression (LR), Naive-Bayes, Random Forest (RF), neural networks (NN), matrix factorization, and Support Vector Machines (SVM) tools may be used for addressing problems in different technological fields.

In general, there are two types of problems in machine-learning: classification problems and regression problems. Classification problems, also referred to as categorization problems, aim at classifying items into one of several category values (for example, is this email SPAM or not SPAM). Regression algorithms aim at quantifying some items (for example, by providing a value that is a real number). Machine-learning algorithms can provide a score (e.g., a number from 1 to 100) to qualify one or more products as a match for a user of the online marketplace. It is contemplated that cluster analysis or clustering can be performed as part of classification, where clustering refers to the task of grouping a set of objects in such a way that objects in the same group (called a cluster) are more similar (in some sense) to each other than to those in other groups (clusters). It is a main task of exploratory data mining, and a common technique for statistical data analysis, used in many fields, including pattern recognition, image analysis, information retrieval, bioinformatics, data compression, computer graphics and machine learning.

Machine-learning algorithms utilize the training data to find correlations among identified features (or combinations of features) that affect an outcome. A trained machine-learning model may be implemented to perform a machine-learning operation based on a combinations of features. An administrator of a machine-learning system may also determine which of the various combinations of features are relevant (e.g., lead to desired results), and which ones are not. The combinations of features determined to be (e.g., classified as) successful are input into a machine-learning algorithm for the machine-learning algorithm to learn which combinations of features (also referred to as “patterns”) are “relevant” and which patterns are “irrelevant.” The machine-learning algorithms utilize features for analyzing the data to generate an output or an assessment. A feature can be an individual measurable property of a phenomenon being observed. The concept of feature is related to that of an explanatory variable used in statistical techniques such as linear regression. Choosing informative, discriminating, and independent features is important for effective operation of the machine-learning system in pattern recognition, classification, and regression. Features may be of different types, such as numeric, strings, and graphs.

The machine-learning algorithms utilize the training data to find correlations among the identified features that affect the outcome or assessment. The training data includes known data for one or more identified features and one or more outcomes. With the training data and the identified features the machine-learning tool is trained. The machine-learning tool determines the relevance of the features as they correlate to the training data. The result of the training is the trained machine-learning model. When the machine-learning model is used to perform an assessment, new data is provided as an input to the trained machine-learning model, and the machine-learning model generates the assessment as output.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computer-implemented method, the method comprising:
means for accessing, for an analytics session, analysis-goal information;
means for selecting, for the analysis goal information, an analysis-goal from a plurality of analysis-goals, wherein the plurality of analysis-goals are identified based on corresponding analysis-goal models;
means for identifying, for the analysis-goal, a probable command that corresponds to the analysis-goal, wherein the probable command is identified based on a plurality of goal-informed models that are trained on a plurality of previous sequences of commands, wherein the plurality of goal-informed models support predicting probable commands for corresponding analysis-goals; and
means for communicating the probable command as a command recommendation for the analysis goal.

2. The method of claim 1, wherein the analysis-goal information is based on a user selection of the analysis-goal from the plurality of analysis-goals, wherein the analysis-information is a phrase representing an analysis-goal having a corresponding analysis-goal model.

3. The method of claim 1, wherein the analysis-goal models are generated using log data, wherein the log data comprises the plurality of previous sequences of commands that are analyzed using a bi-term topic model.

4. The method of claim 1, wherein the plurality of goal-informed models generated based on implicitly incorporating goal information and explicitly incorporating goal information into respective goal-informed models.

5. The method of claim 1, wherein the plurality of goal-informed models are generated based on different machine-learning modeling techniques, wherein the machine-learning techniques are selected from the following: an ensemble technique, a goal concatenated representation technique, a goal concatenated command technique, and a goal appended inputs technique.

6. The method of claim 1, further comprising applying a loss function to the plurality of goal-informed models to fine-tune the plurality of goal-informed model, wherein fine-tuning the plurality of goal-informed models is based on probability distribution

7. The method of claim 1, further comprising generating a goal orientation score that quantifies a degree to which a selected command recommendation aligns with the analysis-goal, wherein the goal orientation indicates is associated with one or more interface elements visually presented using the analytics interface.

8. One or more computer-storage media having computer-executable instructions embodied thereon that, when executed by a computing system having a processor and memory, cause the processor to:
access, for an analytics session, analysis-goal information;
select, for the analysis goal information, an analysis-goal from a plurality of analysis-goals, wherein the plurality of analysis-goals are identified based on corresponding analysis-goal models;
identify, for the analysis-goal, a probable command that corresponds to the analysis-goal, wherein the probable command is identified based on a plurality of goal-informed models that are trained on a plurality of previous sequences of commands, wherein the plurality of goal-informed models support predicting probable commands for corresponding analysis-goals; and
communicate the probable command as a command recommendation for the analysis goal.

9. The media of claim 8, wherein the analysis-goal information is based on a user selection of the analysis-goal from the plurality of analysis-goals, wherein the analysis-information is a phrase representing an analysis-goal having a corresponding analysis-goal model.

10. The media of claim 8, wherein the analysis-goal models are generated using log data, wherein the log data comprises the plurality of previous sequences of commands that are analyzed using a bi-term topic model.

11. The media of claim 8, wherein the plurality of goal-informed models generated based on implicitly incorporating goal information and explicitly incorporating goal information into respective goal-informed models.

12. The media of claim 8, wherein the plurality of goal-informed models are generated based on different machine-learning modeling techniques, wherein the machine-learning techniques are selected from the following: an ensemble technique, a goal concatenated representation technique, a goal concatenated command technique, and a goal appended inputs technique.

13. The media of claim 8, further comprising applying a loss function to the plurality of goal-informed models to fine-tune the plurality of goal-informed model, wherein fine-tuning the plurality of goal-informed models is based on probability distribution

14. The media of claim 8, further comprising generating a goal orientation score that quantifies a degree to which a selected command recommendation aligns with the analysis-goal, wherein the goal orientation indicates is associated with one or more interface elements visually presented using the analytics interface.

15. A computerized system comprising:
means for accessing, for an analytics session, analysis-goal information;
means for selecting, for the analysis goal information, an analysis-goal from a plurality of analysis-goals, wherein the plurality of analysis-goals are identified based on corresponding analysis-goal models;
means for identifying, for the analysis-goal, a probable command that corresponds to the analysis-goal, wherein the probable command is identified based on a plurality of goal-informed models that are trained on a plurality of previous sequences of commands, wherein the plurality of goal-informed models support predicting probable commands for corresponding analysis-goals; and
means for communicating the probable command as a command recommendation for the analysis goal.

16. The system of claim 15, wherein the analysis-goal information is based on a user selection of the analysis-goal from the plurality of analysis-goals, wherein the analysis-information is a phrase representing an analysis-goal having a corresponding analysis-goal model.

17. The system of claim 15, wherein the analysis-goal models are generated using log data, wherein the log data comprises the plurality of previous sequences of commands that are analyzed using a bi-term topic model.

18. The system of claim 15, wherein the plurality of goal-informed models generated based on implicitly incorporating goal information and explicitly incorporating goal information into respective goal-informed models.

19. The system of claim 15, wherein the plurality of goal-informed models are generated based on different machine-learning modeling techniques, wherein the machine-learning techniques are selected from the following: an ensemble technique, a goal concatenated representation technique, a goal concatenated command technique, and a goal appended inputs technique.

20. The system of claim 15, further comprising applying a loss function to the plurality of goal-informed models to fine-tune the plurality of goal-informed model, wherein fine-tuning the plurality of goal-informed models is based on probability distribution
